(19) United States
(12) Patent Application Publication
(10) Pub. No.: US 2022/0117332 A1
(43) Pub. Date: Apr. 21, 2022

(54) RESPIRATORY PERSONAL PROTECTIVE MASK

(71) Applicants: Joseph Andrew Cerabona, Hasbrouck Heights, NJ (US); Thomas Rachelski, Lodi, NJ (US)

(72) Inventors: Joseph Andrew Cerabona, Hasbrouck Heights, NJ (US); Thomas Rachelski, Lodi, NJ (US)

(21) Appl. No.: 16/949,185

(22) Filed: Oct. 19, 2020

(51) Int. Cl. A41D 13/11; A62B 23/02; F16G 11/10

(52) U.S. Cl. CPC A41D 13/1161; A41D 13/1107; F16G 11/101; A62B 23/025

(57) ABSTRACT

A respiratory personal protective mask includes a filter element that is adjustably carried on a drawstring attached to each of a left side and a right side of the filter element. Tabs at each of the left side and the right side of the filter element secure around the drawstring. The tabs may have a releasable fastener, such as Velcro®, to secure the tabs about the drawstring. The drawstring may be an elastic cord or a resilient cord. A toggle is fitted over free ends of the drawstring. The toggle is adjustable along the length of the drawstring to selective position the filter element in a protective position and a standby position.

### BACKGROUND OF THE INVENTION

The present invention relates to personal respiratory protective masks, and more particularly to respiratory protective masks with replaceable mask element.

In the current COVID-19 environment, the use of personal respiratory protective masks has experienced a dramatic increase. While there are many respiratory protective masks, they have many shortcomings. First, the user may remove their mask when not immediately needed and place it on a counter or other location where user risks losing their masks when it is not in use. In other instances, the user may also reposition their mask so that it hangs beneath their chin with the ear loops of the mask still carried on their ears.

The first problem is exacerbated by a second, problem, namely the discomfort caused by masks hanging or suspended behind the ears when in use and not in use. This discomfort may lead some individuals to remove their mask, even in environments where the use of the mask may be indicated.

Additionally, current mask designs limit the user's ability to interchange the filtration element or fabric of the conventional mask. It may be desirable to change this element for cleanliness reasons where the user has worn the mask a number of times or where an exposure event may have occurred. In either event, it is desirable to have a clean filtration element or to remove the filtration element for decontamination or cleaning. Alternatively, the user may simply want to select a filtration element as a fashion alternative that is more coordinated with their attire for a particular occasion.

As can be seen, there is a need for an improved respiratory protective mask.

### SUMMARY OF THE INVENTION

In one aspect of the present invention, a respiratory protective mask is disclosed. The respiratory protective mask includes a filter element having a left side and a right side. The filter element is dimensioned to cover an oral and a nasal opening of a wearer when worn in a protective position. A drawstring is releasably attached to each of the left side and the right side of the filter element. The drawstring has an adjustable length to secure the filter element in the protective position and a ready position.

In some embodiments, a tab extends from each of the left side and the right side of the filter element. A releasable fastener is attached to each tab. The releasable fastener is configured to secure each tab to the drawstring.

In some embodiments, the releasable fastener includes a cooperating fastener. The cooperating fastener may be a hook and a pile material.

In some embodiments, a toggle is configured to slidably adjust a length of the drawstring. The toggle includes a housing having an aperture extending through a lateral side of the housing. A toggle release button has a toggle aperture extending laterally therethrough. In a release condition, the toggle aperture is axially aligned with the aperture. In a secured condition the toggle aperture is offset from the aperture to impinge against the drawstring when carried through each of the aperture and the toggle aperture.

In some embodiments, the filter element is formed of one of a woven or non-woven fabric.

In other aspects of the invention, a respiratory protective mask is disclosed. The respiratory protective mask includes a replaceable filter element having a left side and a right side. The replaceable filter element is dimensioned to cover an oral and a nasal opening of a wearer when worn in a protective position. A tab extends from each of the left side and the right side of the filter element. A releasable fastener is attached to each tab. A drawstring is releasably attached to each of the left side and the right side of the replaceable filter element by cooperative engagement of the releasable fastener. The drawstring has an adjustable length to secure the filter element in the protective position and a ready position.

In some embodiments, the releasable fastener is a hook and a pile material.

In some embodiments, the respiratory protective mask includes a toggle configured to slidably adjust a length of the drawstring. The toggle may include a housing having an aperture extending through a lateral side of the housing. A toggle release button has a toggle aperture extending laterally therethrough. In a release condition, the toggle aperture is axially aligned with the aperture. In a secured condition, the toggle aperture is offset from the aperture to impinge against the drawstring when carried through each of the aperture and the toggle aperture.

These and other features, aspects and advantages of the present invention will become better understood with reference to the following drawings, description and claims.

### BRIEF DESCRIPTION OF THE DRAWINGS

FIG. 1 is a profile view of the respiratory personal protective mask shown in-use in a protective position.

FIG. 2 is a profile view of the mask shown in-use in a ready position.

FIG. 3 is a top view of the mask with a left flap 16 and a right flap 18 shown in an open condition.

FIG. 4 is a top view of the mask with a left flap 16 and a right flap 18 shown closed condition.

FIG. 5 is a section view taken along line 5-5 from FIG. 4.

FIG. 6 is a section view taken along line 6-6 from FIG. 4, with the draw string 20 and a cord lock shown a secured position.

FIG. 7 is a section view similar to FIG. 6, with the cord lock shown in a released position.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention.

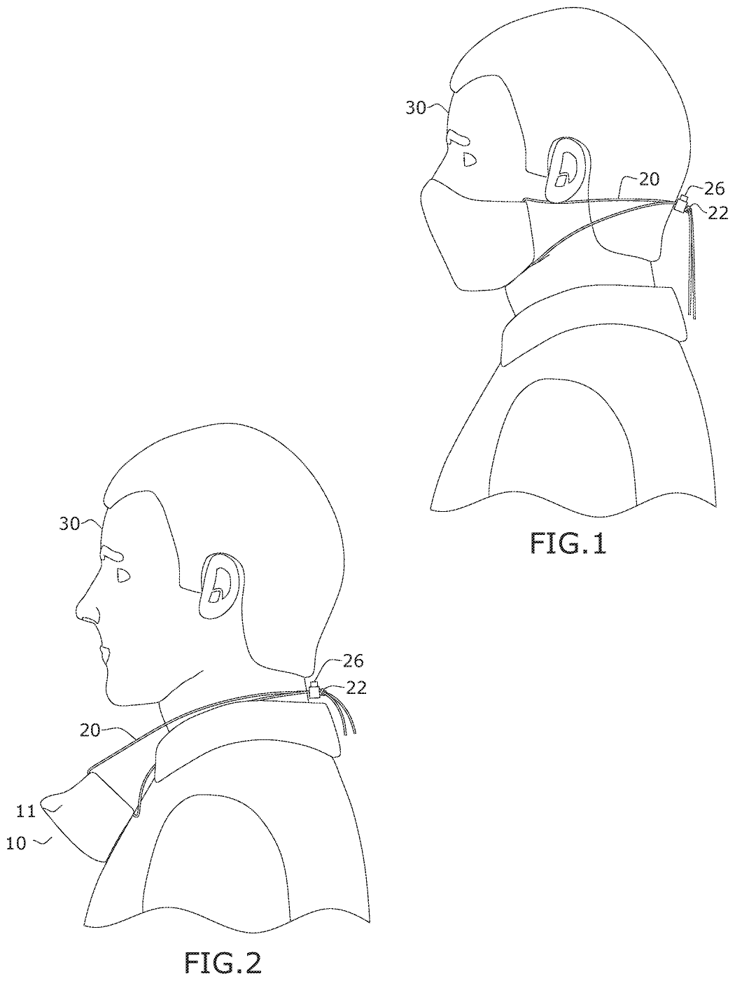

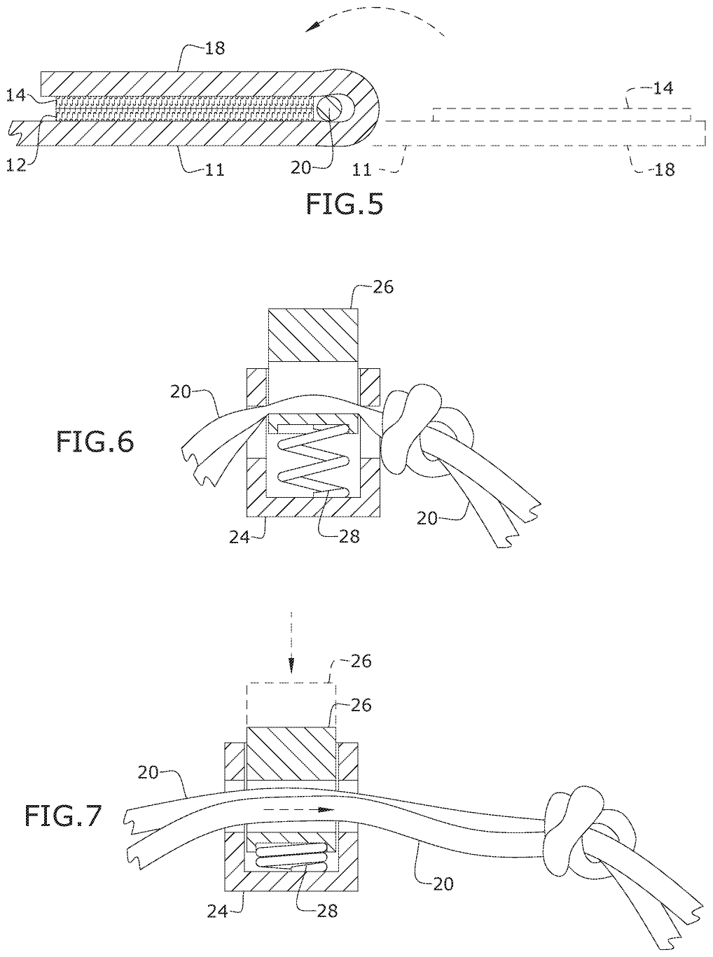

Broadly, embodiments of the present invention provides an improved respiratory personal protective mask. As seen in reference to the drawings of FIGS. 1-5, the personal protective mask 10 includes a filter element 11 that is carried on drawstring 28 attached to each of a left and a right lateral side of the filter element 11. A length of the drawstring 28 is adjustable via a toggle to selectively fit the filter element 11 to the wearer's face in a protective position and a ready position with the mask 10 suspended by the drawstring 28 about the user's neck.

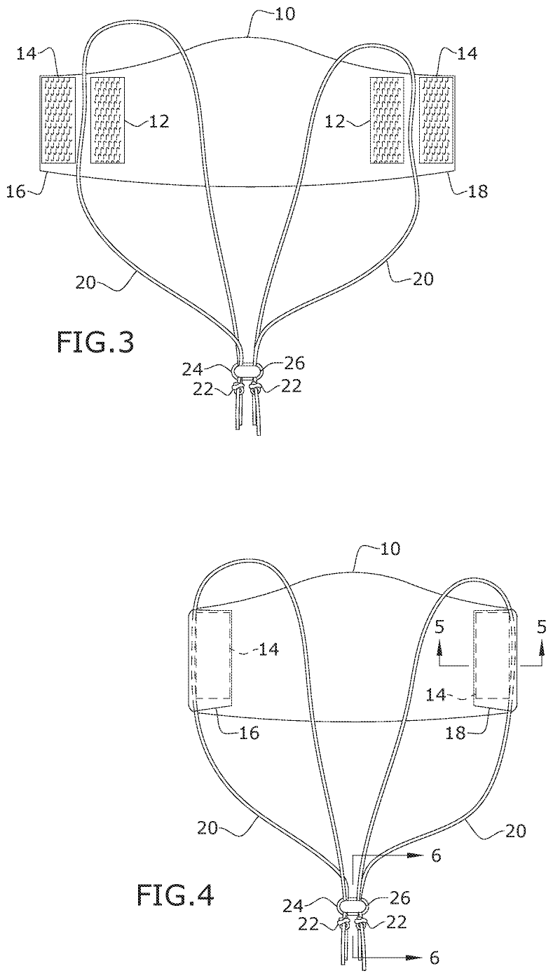

The filter element 11 may be formed of any suitable woven and non-woven fabric for filtration of contaminants, such as aerosolized virus droplets. As seen in reference to FIGS. 3 through 5, the filter element 11 is dimensioned to cover the oral and nasal passages of the user when worn in a protective position. The filter element 11 may include a left 16 and a right 18 tab that are configured to removably attach the filter element 11 to the drawstring 28. The left 16 and the right 18 tabs are releasably secured around the drawstring 28 via a releasable fastener.

In the non-limiting embodiment shown, the releasable fastener may include cooperating fasteners, such as a hook and loop faster such as Velcro®. The hook and loop fastener may include a first patch 12 and a second patch 14 of cooperating hook and loop material. As will be appreciated, the cooperating fasteners may also include a snap, a button, a slide fastener and the like. Preferably, the releasable fastener is configured such that it is carried between the tab 18 and an inner surface of the filter element 11 when in a secured position so as to prevent irritation of the user's face when the mask 10 is worn.

In use, the user may replace the filter element 11 when necessary for disinfecting and cleaning. The user may also replace the filter element 11 for coordination with the user's desired fashion.

As seen in reference to FIGS. 6 and 7, the toggle may include a housing 24 having apertures extending laterally across the housing 24. The apertures are dimensioned to receive the drawstrings 28 therethrough. A toggle release button 26 has a release aperture extending laterally through the toggle release button 16. The toggle button 26 is resiliently carried on a biasing element 28 such as a spring to urge the toggle release button 26 to impinge the drawstrings 28 against the apertures in the housing 24.

In use, the toggle release button 26 is depressed to allow the drawstrings 28 to slide through the aperture and the release aperture. When a desired length is achieved, the toggle release button 26 is released to secure the toggle at a desired position along the drawstrings 28. The drawstrings 28 are preferably formed of an elastic or resilient cord to retain the filter element 11 against the wearer's face without slipping from its protective position from the user's movements or talking.

It should be understood, of course, that the foregoing relates to exemplary embodiments of the invention and that modifications may be made without departing from the spirit and scope of the invention as set forth in the following claims.

What is claimed is:

1. A respiratory protective mask, comprising:
a filter element having a left side and a right side, the filter element dimensioned to cover an oral and a nasal opening of a wearer when worn in a protective position; and
a drawstring releasably attached to each of the left side and the right side of the filter element, the drawstring having an adjustable length to secure the filter element in the protective position and a ready position.

2. The respiratory protective mask of claim 1, further comprising:
a tab extending from each of the left side and the right side of the filter element; and
a releasable fastener attached to each tab, the releasable fastener configured to secure each tab to the drawstring.

3. The respiratory protective mask of claim 2, wherein the releasable fastener includes a cooperating fastener.

4. The respiratory protective mask of claim 3, wherein the cooperating fastener is a hook and a pile material.

5. The respiratory protective mask of claim 1, further comprising:
a toggle configured to slidably adjust a length of the drawstring.

6. The respiratory protective mask of claim 5, wherein the toggle further comprises:
a housing having an aperture extending through a lateral side of the housing; and
a toggle release button having a toggle aperture extending laterally therethrough, wherein in a release condition, the toggle aperture is axially aligned with the aperture, and in a secured condition the toggle aperture is offset from the aperture to impinge against the drawstring when carried through each of the aperture and the toggle aperture.

7. The respiratory protective mask of claim 1, wherein the filter element is formed of one of a woven or non-woven fabric.

8. A respiratory protective mask, comprising:
a replaceable filter element having a left side and a right side, the filter element dimensioned to cover an oral and a nasal opening of a wearer when worn in a protective position, a tab extending from each of the left side and the right side of the filter element, and a releasable fastener attached to each tab; and
a drawstring releasably attached to each of the left side and the right side of the replaceable filter element by cooperative engagement of the releasable fastener, the drawstring having an adjustable length to secure the filter element in the protective position and a ready position.

9. The respiratory protective mask of claim 8, wherein the releasable fastener is a hook and a pile material.

10. The respiratory protective mask of claim 9, further comprising:
a toggle configured to slidably adjust a length of the drawstring.

11. The respiratory protective mask of claim 5, wherein the toggle further comprises:
a housing having an aperture extending through a lateral side of the housing; and
a toggle release button having a toggle aperture extending laterally therethrough, wherein in a release condition, the toggle aperture is axially aligned with the aperture, and in a secured condition the toggle aperture is offset from the aperture to impinge against the drawstring when carried through each of the aperture and the toggle aperture.
